(19) United States
(12) Patent Application Publication
(10) Pub. No.: US 2025/0310711 A1
(43) Pub. Date: Oct. 2, 2025

(54) SEAL-INTEGRITY DIAGNOSTIC SYSTEM

(71) Applicant: Apple Inc., Cupertino, CA (US)

(72) Inventors: Vincenzo COSTANZA, San Diego, CA (US); Gautam NARASIMHAN, San Jose, CA (US); Roberto M. RIBEIRO, Sunnyvale, CA (US); Ankur AGRAWAL, Santa Clara, CA (US); David W. ROBISON, San Jose, CA (US); Eric T. CHIANG, San Francisco, CA (US)

(21) Appl. No.: 19/023,029

(22) Filed: Jan. 15, 2025

Related U.S. Application Data
(60) Provisional application No. 63/572,093, filed on Mar. 29, 2024.

(51) Int. Cl. H04R 29/00; G01M 3/26; H04R 1/02

(52) U.S. Cl. CPC H04R 29/001; G01M 3/26; H04R 1/025; H04R 1/028; H04R 2499/11

(57) ABSTRACT

An apparatus of the subject technology includes a housing, an audio sensor configured to detect an acoustic pressure in a cavity of the housing, and a processor configured to determine a level of a leak of the housing based at least in part on the acoustic pressure.

### CROSS-REFERENCE TO RELATED APPLICATION(S)

This application claims the benefit of U.S. Provisional Application Ser. No. 63/572,093, entitled “SEAL-INTEGRITY DIAGNOSTIC SYSTEM,” and filed on Mar. 29, 2024, the disclosure of which is expressly incorporated by reference herein in its entirety.

### TECHNICAL FIELD

The present description relates generally to electronic devices, for example, to an electronic device having a seal-integrity diagnostic system.

### BACKGROUND

Electronic devices, such as watches and phones, are increasingly being used during water-based activities, for example, swimming, scuba diving, showering, and other water-based activities. Therefore, seal integrity plays an important role in the proper functioning of the devices as water ingress could damage the internal electronic components. Although electronic devices are tested for seal integrity before shipping, they could become compromised during the course of their use because of wear and tear, cracks, corrosion, and the like.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a high-level block diagram illustrating an example of a system within which certain aspects of the subject technology are implemented.

FIG. 2 is a schematic diagram illustrating an example of a system with seal-integrity diagnostic features, according to one or more implementations of the subject technology.

FIG. 3 is a flow diagram illustrating an example of a process for acoustic seal-integrity diagnosis, according to one or more implementations of the subject technology.

FIG. 4 is a chart illustrating an example of frequency variations of acoustic pressure-change of an acoustic seal-integrity diagnostic device, according to one or more implementations of the subject technology.

FIG. 5 is a chart illustrating another example of frequency variations of acoustic pressure-change of an acoustic seal-integrity diagnostic device, according to one or more implementations of the subject technology.

FIG. 6 is a schematic diagram illustrating an example of an apparatus using a seal-integrity diagnostic system, according to one or more implementations of the subject technology.

FIGS. 7 and 8 are charts illustrating examples of pressure-change time variations of an acoustic seal-integrity diagnostic device, according to one or more implementations of the subject technology.

FIG. 9 is a chart illustrating an example of time variations of pressure-change due to temperature change of an acoustic seal-integrity diagnostic device, according to one or more implementations of the subject technology.

FIG. 10 is a flow diagram illustrating an example of a process for seal-integrity diagnosis, according to one or more implementations of the subject technology.

FIG. 11 is a flow diagram illustrating an example of a process for acoustic seal-integrity diagnosis, according to one or more implementations of the subject technology.

FIG. 12 is a flow diagram illustrating an example of a process for seal-integrity diagnosis, according to one or more implementations of the subject technology.

FIG. 13 is a flow diagram illustrating an example of a process for seal-integrity diagnosis, according to one or more implementations of the subject technology.

FIG. 14 is a schematic diagram illustrating an example of an electronic device within which aspects of the subject technology may be implemented.

### DETAILED DESCRIPTION

The detailed description set forth below is intended as a description of various configurations of the subject technology, and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein, and can be practiced using one or more other implementations. In one or more implementations, structures and components are shown in block diagram form in order to avoid obscuring the concepts of the subject technology.

Embodiments of the subject technology provide for a built-in seal-integrity diagnostics system that can help users gain confidence on seal integrity of their devices and warn them of potential issues before they take the devices to water-based activities. In some aspects, the subject technology is directed to an electronic device having a seal-integrity diagnostic system. The electronic device includes a housing, an audio sensor configured to detect an acoustic pressure in a cavity of the housing, and a processor configured to determine a seal-quality metric of the housing based at least in part on the acoustic pressure.

In one or more other implementations, an electronic device of the subject technology includes a housing, a first sensor, a second sensor, and a processor. The first sensor is a pressure sensor that measures a first pressure that is an internal pressure of the housing. The second (optional) sensor measures a second pressure that is an external pressure. The processor determines a seal-quality metric of the housing based on the first pressure and the second pressure.

The seal-quality metric is measure of a level of a leak of the housing. In one or more implementations, the processor activates a pressure-change stimulus to cause a change in the first pressure. The pressure-change stimulus can be a touch stimulus that is activated by sending a message to a user. In one or more implementations, the electronic device of the subject technology further includes an audio driver, and a speaker, and the pressure-change stimulus is an audio stimulus. For example, the processor can activate the pressure-change stimulus by causing the audio driver to play an audio signal on the speaker. The processor can determine a delta pressure by subtracting the second pressure from the first pressure and comparing the delta pressure with a predetermined value. In one or more implementations, the processor reports a leak of the housing based on a comparison of the delta pressure with the predetermined value.

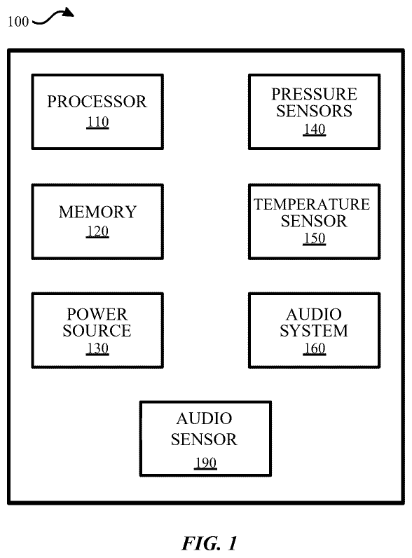

FIG. 1 is a high-level block diagram illustrating an example of a system 100 within which certain aspects of the subject technology are implemented. In one or more implementations, the system 100 can be, but is not limited to, an electronic device such as a hand-held communication device, for example a watch (e.g., a smartwatch), or a phone (e.g., a smartphone). In one or more implementations, the system 100 is enclosed in a sealed housing that prevents water, and other liquids, ingress. The system 100 includes, but is not limited to, a processor 110, a memory 120, a power source 130, one or more pressure sensors 140, a temperature sensor 150, an audio system 160, and an audio sensor 190. The processor 110 can be a general processor of the electronic device or a dedicated processor.

The one or more pressure sensors 140 include at least one internal pressure sensor and one external pressure sensor for measuring an internal pressure of a cavity of the sealed housing and the external pressure, respectively. In one or more implementations, the processor 110 uses the measured pressure of the internal and external pressure sensor to detect a leak in a seal of the housing.

In an example, the power source 130 is used to charge a power source (e.g., battery) of the apparatus 100. The charging of the power source, for example, can result in a temperature increase inside the cavity of the housing. The temperature change inside the housing can be measured by the temperature sensor 150. In one or more implementations, the processor 110 can use the temperature rise of the cavity of the housing due to charging by the power source 130 to detect a leak of the housing.

The audio system 160 may include, but is not limited to, an audio driver and one or more speakers. The audio driver generates electrical signals with frequencies within an audio band (e.g., a few Hz to about 20 KHz), and provides the electrical signal to the speaker(s) to be played as an audio signal. In one or more implementations, tones with other frequencies, for example, frequencies inaudible to humans can also be used. In one or more implementations, the processor 110 uses the audio system 160 to diagnose a leak in the seal of the housing, as discussed in more detail herein.

The audio sensor 190 may include, but is not limited to, a microphone. The audio sensor 190 may detect an acoustic pressure within the cavity. The processor 110 may determine a frequency-dependent signature from the detected acoustic pressure. In one or more implementations, the processor 110 uses the frequency-dependent signature from the audio sensor 190 to diagnose a leak in the seal of the housing, as discussed in more detail herein.

The processor 110 can use the memory 120 to store information including static pressure changes, acoustic pressure changes, temperature changes, and other useful information.

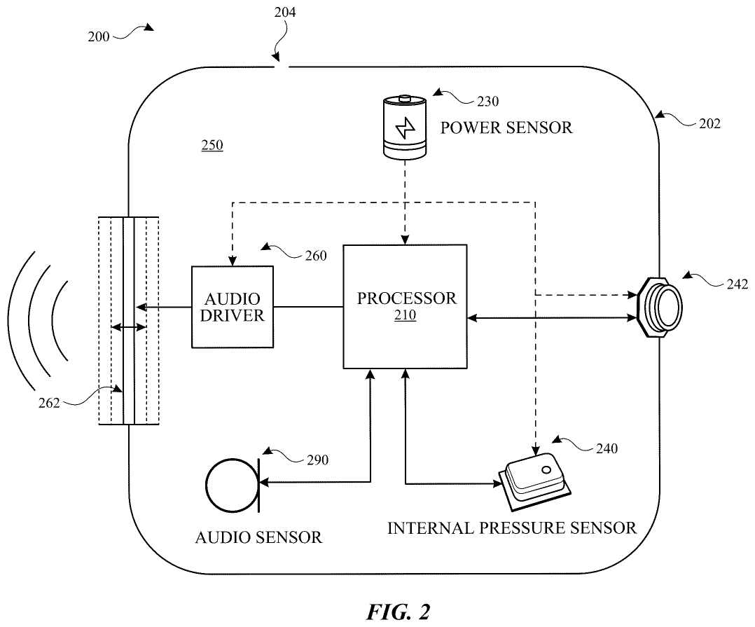

In one or more implementations, the subject technology addresses static pressure dynamics utilizing a static pressure sensor to monitor pressure variations within an electronic device such as a watch, indicative of leakages. The principle involves inducing a pressure differential between the watch's interior and the external environment, achieved through either compressing the watch or altering the volume via a speaker. This manipulation results in a pressure buildup within the cavity of the watch, subsequently declining over time as the internal pressure equalizes with the external pressure. The rate of pressure equalization differs depending on the presence of leaks. In one or more other implementations, the subject technology provides for employing an audio sensor such as a microphone as an additional sensor due to its inherent capabilities. For example, the inherent characteristics that make a microphone a good audio sensor include sensitivity for accurate sound wave conversion, a wide frequency response range, directionality to capture specific sounds, a high signal-to-noise ratio for clear recordings, durability, and impedance matching for optimal signal transfer. The subject technology can generate an alternating acoustic pressure within the watch, as opposed to a static pressure. The presence or absence of leaks can then be discerned by analyzing the frequency-dependent signature of the acoustic pressure detected by the microphone. For example, the embodiments described in FIGS. 2 and 6-11 provide for the measurement of static pressure decay and the embodiments described in FIGS. 2-5 provide for the detection of changes in the resonance of acoustic pressure using the audio sensor.

FIG. 2 is a schematic diagram illustrating an example of a system 200 with seal-integrity diagnostic features, according to one or more implementations of the subject technology. In one or more implementations, the apparatus 200 is, but is not limited to, an electronic device such as a hand-held communication device, for example, a watch (e.g., a smartwatch), or a phone (e.g., a smartphone). The apparatus 200 includes, but is not limited to, a housing 202, a vent 204, a processor 210 (e.g., a central processing unit (CPU)), a power source 230, a first pressure sensor 240, a second pressure sensor 242, a cavity 250, an audio driver 260, a speaker 262 and an audio sensor 290. The first pressure sensor 240 is an internal pressure sensor and measures an internal pressure as well as pressure change in the cavity 250. The second pressure sensor 242 is an external pressure sensor and measures the external pressure.

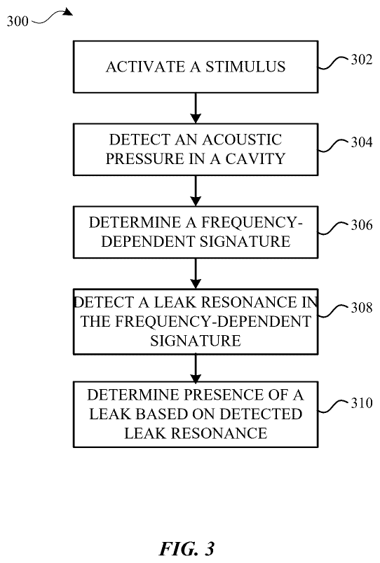

In one or more implementations, the processor 210 can use the audio sensor 290, as described with reference to FIG. 3. The processor 210, using the audio sensor 290, can detect an acoustic pressure in the cavity 250 of the apparatus 200. The processor 210 can determine a frequency-dependent signature of the acoustic pressure. In one or more other implementations, the processor 210 can use the audio driver to play an audio signal on the speaker 262 and analyze the acoustic pressure change detected by the audio sensor 290 to determine a frequency-dependent signature of the acoustic pressure. The processor 210 can determine the presence of a leak within the cavity 250 based at least in part on the frequency-dependent signature of the acoustic pressure.

In one or more implementations, the apparatus 200 utilizes the audio sensor 290 as a potential static pressure sensor, eliminating the need for an additional pressure sensor in the cavity 240. The rationale for incorporating the audio sensor 290 lies in the need to integrate an additional pressure sensor to ascertain specific time constants, whereas the audio sensor 290 may already be integrated into the system. Thus, leveraging an existing microphone component is preferable to adding another pressure sensor.

In one or more implementations, both the pressure sensor and audio sensor 290 can operate independently. In one or more other implementations, to improve signal-to-noise ratio and enhance confidence in the output, both sensors (e.g., internal pressure sensor 240, audio sensor 290) can be used concurrently and merge their data. This approach ensures a more robust assessment of the seal quality. When merging the data from both the audio sensor 290 and the internal pressure sensor 240, their values may be weighted equally without bias towards one or the other.

In one or more implementations, the audio sensor 290 and the internal pressure sensor 240 can function independently of each other. For example, if the internal pressure sensor 240 malfunctions, the audio sensor 290 can still perform its function. However, for the apparatus 200 to operate effectively, the functionality of the speaker 262 is important. Therefore, the audio sensor 290 can be used to verify the speaker's 262 functionality, establishing a dependency of the internal pressure sensor 240 on the audio sensor 290 for this specific purpose.

In one or more other implementations, the processor 210 can use the audio driver to play an audio signal on the speaker 262 and analyze the pressure change measured by the first pressure sensor 240 to determine an amplitude and decay-time constant of the pressure signal received from the first pressure sensor 240.

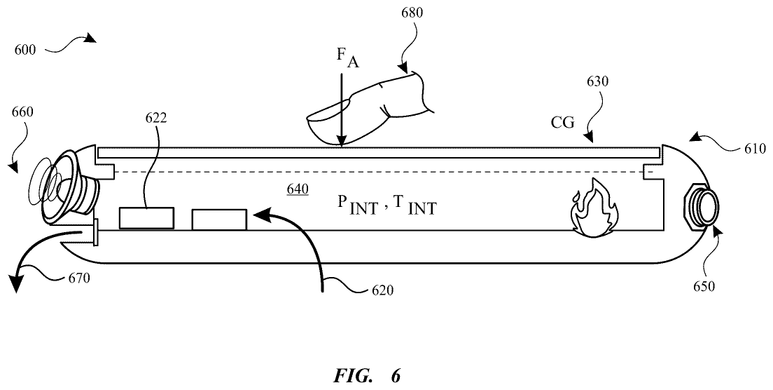

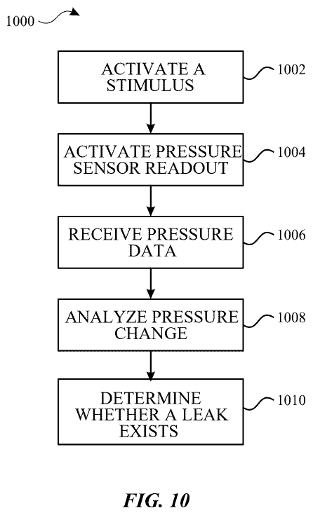

In one or more other implementations, the processor 210 can use a touch stimulus, as described with respect to FIG. 10, and determine whether it is safe or unsafe for the apparatus 200 to be exposed to a liquid (e.g., water), as described with respect to FIG. 6.

In one or more other implementations, the processor 210 can use a temperature stimulus, as described with respect to FIG. 10, and determine whether the seal integrity of the housing 202 is breached based on a change in pressure (ΔP) due to the change in the temperature (ΔT). The change in the temperature can be due to the heat of charging the power source 230 by a charger or a thermal virus. The change in temperature (ΔT) leads to a change in pressure according to the ideal gas law (PV=nRT). Running a thermal virus creates a positive ΔT, which leads to a positive ΔP. Turning off the thermal virus would cause the pressure change ΔP to slowly decay down to zero, for which the decay constant can be calculated.

FIG. 3 is a flow diagram illustrating an example of a process 300 for acoustic seal-integrity diagnosis, according to one or more implementations of the subject technology. For explanatory purposes, the process 300 is primarily described herein with reference to the apparatus 200. However, the process 300 is not limited to the apparatus 200, and one or more blocks (or operations) of the process 300 may be performed by one or more other components of other suitable devices and/or servers. Further for explanatory purposes, some of the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

The process 300 starts at operation block 302, where the processor 210 of FIG. 2 initiate the process by activating a stimulus, such as an audio stimulus. In one or more implementations, the processor 210 (FIG. 2) causes the audio driver 260 (FIG. 2) to emit an audio tone through the speaker 262 (FIG. 2) within a frequency range of about 10 Hz to about 2 kHz, and further causes recordation of the audio sensor 290 (FIG. 2) output across various calibrated leaks present in the apparatus 200. In terms of the acoustic model used to measure these resonances, the processor 210 can receive an audio data output from the audio sensor 290 and sweep through a range of frequencies captured in the audio data to identify where the resonance occurs. In one or more implementations, resonances may not occur at precise frequencies for every unit, necessitating a frequency sweep to locate them accurately. To perform this frequency sweep, a single tone is emitted by the speaker 262 across the frequency range of about 10 Hz to about 2 kHz.

At operation block 304, the processor 210, using the audio sensor 290 of FIG. 2, can detect an acoustic pressure in the cavity 250 of the apparatus 200 of FIG. 2. Embodiments of the subject technology provide for analyzing the output from the audio sensor 290 (FIG. 2) to determine leak presence at particular frequencies. In one or more other implementations, embodiments of the subject technology also consider the decay of pressure, which necessitates using both the internal pressure sensor 240 and the audio sensor 290 in the frequency domain, not the time domain. In one or more implementations, the audio sensor 290 can monitor pressure decay over time, similar to the function of a pressure sensor (e.g., the internal pressure sensor 240). In one or more other implementations, the audio sensor 290 may detect one or more portions of the pressure decay due to inherent limitations in microphone sensitivity at lower frequencies. In one or more implementations, the front volume pressure of the audio sensor 290 may equalize through an equalization vent into the internal volume of the apparatus 200, which equalizes with the external pressure. This equalization vent can facilitate achieving an estimated coupling loss (ECL) resolution down to a certain frequency (e.g., 20 Hz).

At operation block 306, the processor 210 can determine a frequency-dependent acoustic signature of the detected acoustic pressure. In one or more implementations, the frequency-dependent acoustic signature can refer to the unique pattern of sound intensity variations across different frequencies. This signature can represent how the pressure of acoustic waves varies with frequency, reflecting the characteristics of the sound source and the medium through which the sound propagates. Analyzing this signature provides valuable information about the nature and properties of the sound, enabling detection of a leak. In one or more implementations, the audio sensor 290 is implemented alongside one or more pressure sensors. Therefore, the internal pressure sensor 240 (FIG. 2) can be utilized in tandem with the audio sensor 290 in capturing and analyzing the frequency-dependent acoustic signature. In one or more other implementations, the audio sensor 290 is implemented instead of the internal pressure sensor 240. In this regard, the audio sensor 290 can function as a standalone sensor in capturing and analyzing the frequency-dependent acoustic signature.

At operation block 308, the processor 210 can detect a leak resonance in the frequency-dependent acoustic signature. Detecting a leak resonance from the frequency-dependent acoustic signature involves analyzing the pattern of sound intensity variations across different frequencies to identify a distinct peak or resonance associated with the leak. This resonance occurs when the leak introduces a specific frequency component to the acoustic signature due to the interaction between the escaping fluid and the surrounding environment. By sweeping the frequency spectrum captured by the audio sensor 290, the processor 210 can identify and isolate this resonance peak, enabling the detection and localization of leaks in the apparatus 200.

At operation block 310, the processor 210 can determine presence of a leak based on the detected leak resonance. By analyzing the frequency response of the audio sensor 290 when subjected to the speaker 262 output of the apparatus 200, variations in the shape of the frequency response indicate the presence or absence of a leak. In one or more implementations, leak detection relies on comparing resonance frequencies to specified values, aiding in the identification of leaks. For example, these detected resonance frequencies can be compared with known leak resonance frequencies or expected resonance frequencies for the housing 202 (FIG. 2). In one or more implementations, the processor 210 can compare the amplitude of the leak resonance to a threshold for resonance amplitudes or frequencies that indicates a leak is present. When the detected resonance exceeds this threshold, the processor 210 can signal the presence of a leak in the housing 202.

The classification of the leak frequency involves the processor 210 analyzing various metrics to determine if it exceeds expected values. In one or more implementations, metrics such as power peaks, Q factor, and others are considered for comparison. During factory testing, large-scale data collection can be performed to establish the frequency range for units with no leaks. This data serves as a basis for determining a threshold value. However, due to factors like variations in volume contents and system size, establishing a fixed threshold may not be feasible, subjecting to experimental determination.

In one or more implementations, the acoustic impedance of leaks increases with frequency. Consequently, when leaks are detected at higher frequencies, the amplitude also increases because the resonance occurs at a higher frequency. This may illustrate a compromise between frequency and leak size. When the leak size is very small, acoustic waves with wavelengths much larger than the leak do not interact with it. This can facilitate determining the minimum detectable leak size based on the frequency of the emitted acoustic wave. For example, if a 1μ leak diameter is exposed to a 1 kHz acoustic wave, the interaction can be minimal due to the large wavelength compared to the leak size. Consequently, the resonance associated with small leaks may not be detected as the required high frequencies may not be generated by the speaker 262. This potential trade-off impacts the sensitivity of leak detection, limiting the detection capability to leaks within a certain size range.

Smaller leaks may be detectable by the internal pressure sensor 240. However, challenges arise due to the presence of an existing large leak within the apparatus 200, caused by the speaker 262 membrane. In this regard, the processor 210 can attempt to measure a change in decay rate atop an already existing decay rate. In one or more implementations, if the decay rate change is significantly smaller than the standard time constant (e.g., three seconds), for example, one millisecond, it becomes questionable whether this change can be effectively measured. In one or more other implementations, sensitivity may be limited by the small magnitude of the change in time constant relative to the baseline.

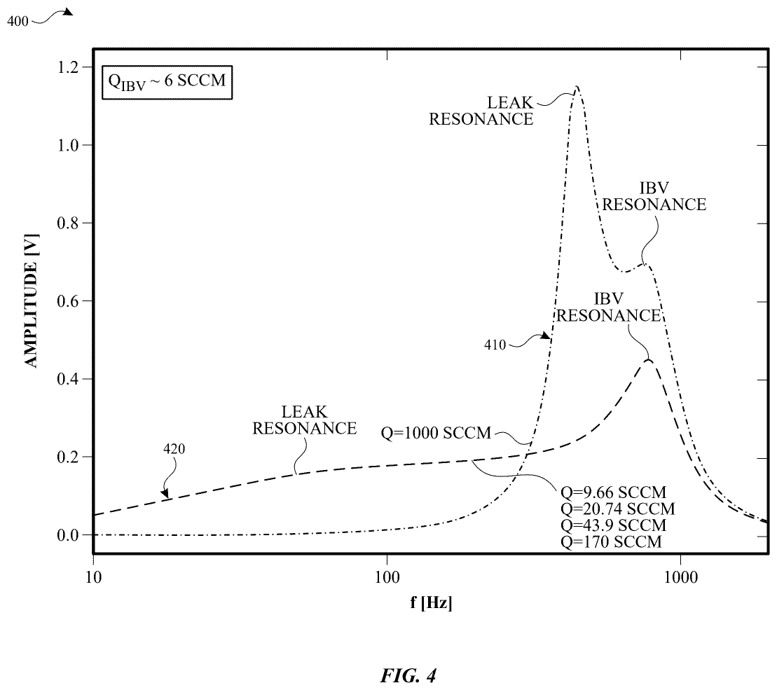

FIG. 4 is a chart illustrating an example of frequency variations of acoustic pressure-change of an acoustic seal-integrity diagnostic device, according to one or more implementations of the subject technology. The plot 400 demonstrates that larger leaks result in a rapid pressure drop, while smaller leaks cause a slower decrease in pressure over time. The time constant for this decay ranges from hundreds of milliseconds to a couple of seconds. However, when attempting to measure the same signal with the audio sensor 290 (FIG. 2), it becomes apparent that the audio sensor 290 can detect the rapid pressure decay but may perceive limited changes in pressure for slower leaks beyond a certain time constant. The plotted data in FIG. 4 illustrates that the audio sensor 290 may not serve as a substitute for the pressure sensor. Instead, if utilizing the audio sensor 290, a distinct sensing mechanism in the frequency domain can be employed alongside the pressure sensor for pressure decay analysis.

In one or more implementations, the processor 210 (FIG. 2) causes the audio driver 260 (FIG. 2) to emit an audio tone through the speaker 262 (FIG. 2) within a frequency range of about 10 Hz to about 2 kHz, and further causes recordation of the audio sensor 290 output across various calibrated leaks present in the apparatus 200. Each leak can be represented by a distinct curve on the plot 400. For example, a substantial change in the audio sensor 290 output reading is observed when transitioning from a larger leak (about 1,000 SCCM, depicted by curve 410) to a smaller leak (in a range of about 9 SCCM to about 170 SCCM, depicted by curve 420). The audio sensor 290 output is monitored while the speaker 262 emits the audio tone, and any alterations in this acoustic signal indicate the presence of a leak. This change in the acoustic signal can be attributed to the acoustic pressure interacting with the geometry of the cavity 250 of the apparatus 200, resulting in a unique signal shape depending on the presence or absence of a leak.

In one or more implementations, the sensitivity of the audio sensor 290 allows for the detection of significant leaks. In one or more other implementations, the sensitivity of the audio sensor 290 allows for the detection of smaller leaks. For example, a leak of 1000 SCCM exhibits a distinct difference compared to a leak of 0.6 SCCM. In one or more implementations, when comparing leaks of 20 and 50 SCCM, the audio sensor 290 may partially differentiate between them.

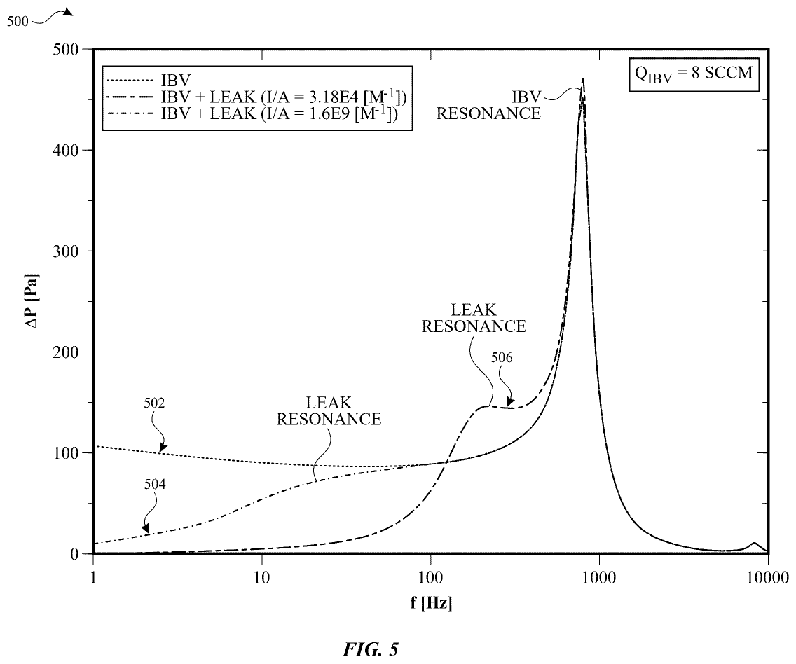

FIG. 5 is a chart illustrating another example of frequency variations of acoustic pressure-change of an acoustic seal-integrity diagnostic device, according to one or more implementations of the subject technology. The plot 500 in FIG. 5 illustrates three distinct leaks (depicted as curves 502, 504 and 506), each characterized by varying airflow rates. In one or more implementations, the plot 500 in FIG. 5 demonstrates why there is a pronounced resonance region in the plotted data in plot 400 in FIG. 4. When a leak is present, it acts as an additional resonator at specific frequencies, as illustrated in plot 5. Each additional leak introduces another resonance, and the size of the leak determines the frequency at which this resonance occurs. Therefore, the plotted data in FIG. 5 serves as confirmation of the plotted data in FIG. 4, facilitating to explain the frequency behavior of the acoustic pressure in the presence of leaks.

In terms of the acoustic model used to measure these resonances, the processor 210 (FIG. 2) can receive an audio data output from the audio sensor 290 (FIG. 2) and sweep through a range of frequencies captured in the audio data to identify where the resonance occurs. In one or more implementations, resonances may not occur at precise frequencies for every unit, necessitating a frequency sweep to locate them accurately. To perform this frequency sweep, a single tone is emitted by the speaker 262 (FIG. 2) across the frequency range of about 10 Hz to about 2 kHz. As the speaker 262 generates these frequencies, the audio sensor 290 captures them, enabling the reconstruction of the plot 500 in FIG. 5.

FIG. 6 is a schematic diagram illustrating an example of an apparatus 600 using a seal-integrity diagnostic system, according to one or more implementations of the subject technology. In one or more implementations, the apparatus 600 is, but is not limited to, an electronic device such as a hand-held communication device, for example, a watch (e.g., a smartwatch), or a phone (e.g., a smartphone). The apparatus 600 includes, but is not limited to, a housing 610, a first pressure sensor 620, a temperature sensor 622, a cover glass (CG) 630, a cavity 640, a second pressure sensor 650, a speaker 660, a vent 670. The apparatus 600 also can include a processor, memory, a power source, an audio driver, and a temperature sensor that are parts of the of the seal-integrity diagnostic system but not shown in FIG. 6 for clarity.

In one or more implementations, the first pressure sensor 620 is a barometric pressure sensor internal to the apparatus 600 and can effectively measure the pressure (P_{INT}) inside a constant volume of the cavity 640 at a given temperature (T_{INT}). The first pressure sensor 620 can output a known pressure signal in response to known inputs. However, if the seal of the apparatus 600 is breached, the cavity cannot be considered a constant volume system anymore, and the pressure response to the known input would deviate from the sealed system response. In one or more implementations, the second pressure sensor 650 can be used for calibration of the first pressure sensor 620, the discussion of which is not within the scope of the present disclosure. The apparatus 600 can use a number of stimuli (inputs) that can cause pressure change inside the cavity 640 for the seal-integrity diagnostic. Examples of the stimuli include, but are not limited to, acoustic, touch, and temperature inputs such as thermal virus, as discussed herein.

In one or more implementations, when an audio is played on the speaker 660, the movement of the speaker membrane would displace air inside the cavity 640. In one or more implementations, the speaker 660 is an internally ported speaker or uses the cavity 640 as a back volume. The air displacement would generate a pressure change, which can vary with the level of seal degradation. The level of seal degradation could be measured either from the amplitude, or decay-time constant of the output of the first pressure sensor 620. For example, the processor (e.g., 110 of FIG. 1) can receive the output of the first pressure sensor 620 as pressure signals, and analyze the signals to retrieve the amplitude and time constant.

In one or more implementations, the processor may activate a pressure-change stimulus by causing an audio driver to play an audio signal on the speaker 660, which results in pressure change in the cavity 640. In one or more implementations, the processor may periodically run a seal-quality metric evaluation by causing the audio driver to play an audio on the speaker 660. The processor may analyze the corresponding signals received from the first pressure sensor 620 and make a database of periodic runs by storing the measured amplitude and time constant values in the memory.

In one or more implementations, touching or pressing the CG 630 of the apparatus display by an input device, such as, but not limited to, a finger 680 of a user, can deform the CG 630, which effectively reduces the volume of the cavity 640. When the housing 610 is sealed, the decrease in the volume of the cavity 640 would produce a pressure change inversely proportional to the volume. If the seal of the housing 610 is degraded, the resulting air leaks produce a weaker pressure signal from the first pressure sensor 620, which can be used by the processor to determine the presence of a seal leak and/or a level of seal degradation. In one or more implementations, a user of the apparatus may enter a respective user interface (UI) on the apparatus 600 and touch (press) the CG 630 before entering water, for example, for swimming, scuba diving, or other water activities, and obtain a seal-integrity result shown on the display. For example, the processor may respond to the pressure change within the cavity 640 due to the touch-and-read signals from the first pressure sensor 620 for analysis and seal-integrity determination. The processor may report the result of the seal-integrity determination to the UI on the display, for example, by displaying “safe” when the seal integrity is not degraded, and “unsafe” when the seal integrity is breached. It is noted that the applied pressure-change stimulus has to be able to generate an internal pressure change faster than due to the vent 670.

In one or more implementations, an increase in temperature of the air inside the cavity 640, e.g., while charging the power source or by means of a thermal virus, would lead to an increase in pressure. This is because of the ideal gas law (PV=nRT). A constant volume V of the cavity 640 results in a corresponding pressure change ΔP, which can be expressed as: ΔP=nRΔT/V, where ΔT represents the change in the temperature as measured by the temperature sensor 622. When the seal of the housing 610 is breached, the change in the pressure (ΔP) due to change in the temperature (ΔT) would ramp down, when a marginal seal failure is detected, or not exist at all when a gross seal failure is detected.

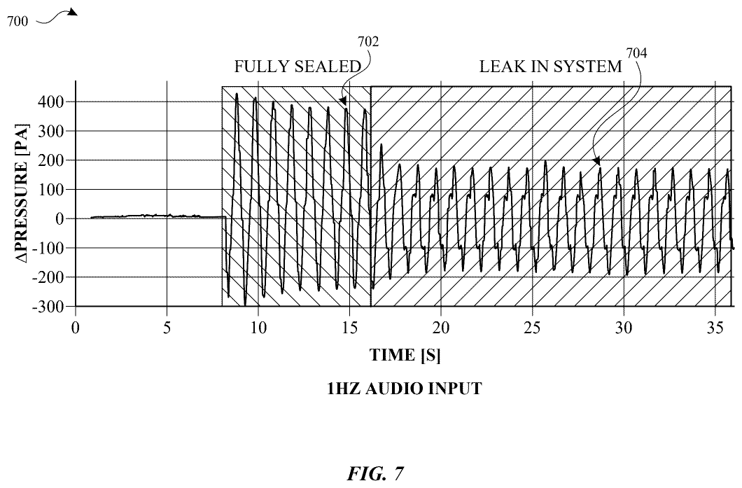

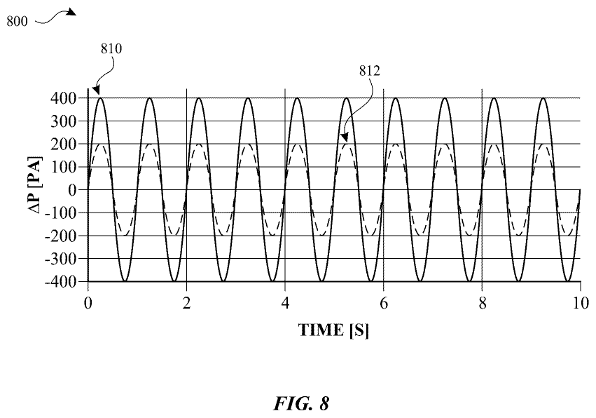

FIGS. 7 and 8 are charts 700 and 800, respectively, illustrating examples of pressure-change time variations of an acoustic seal-integrity diagnostic device, according to one or more implementations of the subject technology. As discussed above with respect to FIGS. 2 and 6, the processor 210 can analyze a response of the first pressure sensor 240 of FIG. 2 (or 620 of FIG. 6) to an audio stimulus caused by vibrations due to the speaker 262 of FIG. 2 (or 660 of FIG. 6) playing an audio signal. In the example of the chart 700, the change in pressure (ΔP) versus time (in seconds) follows the audio signal, which is a sinusoidal signal with a frequency of about 1 Hz. The change in absolute values of amplitudes between sections 702 and 704 of the chart 700 can be used by the processor to determine whether a breach in the seal of the housing exists.

In one or more implementations, the processor can also determine a decay-time constant of the sections 702 and 704 of the chart 700, and utilize the decay-time constant to characterize a leak in the seal of the housing. The ΔP reading of section 702 is indicative of the seal integrity of a device being intact, whereas the ΔP reading of section 703 is indicative of the seal integrity of the device being compromised. In an example, if a pressure reading or ΔP is below a threshold value the device is considered to have a compromised seal. In an example, if the magnitude of a ΔP change exceeds a threshold the device is considered to have a compromised seal. In one or more implementations, an audio frequency and amplitude input that produces the highest-pressure change is desired to achieve the highest sensitivity. This frequency would change with the internal structure of the device. However, in general, lower the frequency, greater the speaker membrane displacement (within physical limits of the speaker). Also, using a frequency less than 20 Hz would be inaudible, making it a better user experience.

In one or more implementations, after recording internal pressure change due to a stimulus (audio/temperature/touch), the change in pressure ΔP can be calculated in two ways using a first or a second method (or a combination of both, using sensor fusion algorithms, which is not within the scope of the present disclosure). In the first method, a pressure difference relative to the outside pressure (ΔP(t)=Pᵢₙₜ(t)−Pₑₓₜ(t)) is used. In the second method, a pressure difference relative to internal pressure at the start of algorithm (t=0)(ΔP(t)=Pᵢₙₜ(t)−Pᵢₙₜ(0)) is utilized. The benefit of using the external pressure sensor is that the changes in pressure due to environmental changes (e.g., due to turning on/off an air conditioning system, opening one or more doors and/or windows, etc.) can be cancelled out. Some quality metrics are defined and the threshold values are measured at the factory (fully sealed system) as calibration values by running the similar stimuli (acoustic, thermal virus or touch on the display) and measuring ΔP(t) for a predetermined time interval (e.g., 10 seconds). Examples of quality metrics include, but is not limited to, a root-mean-square (RMS) of ΔP(t) and a decay constant of ΔP(t).

As shown in the example chart 800, for an acoustic input, ΔP(t) is a sinusoidal output, and the RMS of the output signal would give a single value for the signal. The chart 800 includes plots 810 and 812. The plot 810 shows a sinusoidal output measured at the factory on a fully sealed system with an RMS value ΔP_{rms,thresh} (e.g., 800/√2=282 Pa) saved in memory on the device. The plot 812 depicts a sinusoidal output measured when the same system is later run in the field. The measured RMS value ΔPᵣₘₛ (e.g., 141 Pa) is seen to be less than ΔPᵣₘₛ, thresh (e.g., 282 Pa), which is an indication that a leak exists.

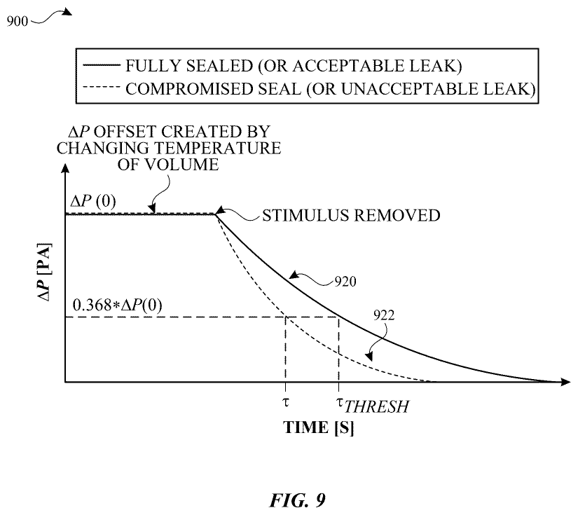

FIG. 9 is a chart 900 illustrating example plots 920 and 922 of time variations of pressure-change due to temperature change of an acoustic seal-integrity diagnostic device, according to one or more implementations of the subject technology. The plot 920 correspond to a fully sealed system (e.g., measured in the factory) and the plot 922 corresponds to a compromised seal measured in the field. Given a non-zero ΔP(t), and all stimuli turned off, ΔP(t) would slowly decay down to zero (e.g., as shown by plot 920). This is because all systems have some level of acceptable air leak (e.g., considered sealed for all practical purposes until certain water depth). A non-zero ΔP(t) can be created by change in temperature (e.g., running a speaker that generates heat) or change in cavity volume by touch. The decay constant t is a property defining the time it takes for ΔP(t) to decay down to 36.8% of its original value (ΔP(0)), as defined by an exponential expression (ΔP(t)=ΔP(0) e^{-t/T}). A larger decay constant indicates a smaller leak rate. The decay constant measured at the factory on a fully sealed system tₜₕᵣₑₛₕ is saved in memory on the device. When the same system is later run in the field (e.g., plot 922), a decay-constant value t less than tₜₕᵣₑₛₕ would indicate a leak.

FIG. 10 is a flow diagram illustrating an example of a process 1000 for seal-integrity diagnosis, according to one or more implementations of the subject technology. The process 1000 is a process of seal-integrity diagnosis by using an internal pressure change of the cavity (e.g., 250 of FIG. 2) of an apparatus (e.g., an electronic device) such as the apparatus 200 of FIG. 2. The process 1000 starts at operation block 1002, where the processor 210 of FIG. 2 initiate the process by activating a stimulus, such as an audio stimulus, a touch stimulus, or a temperature stimulus. At operation block 1004, the processor 210 activates a pressure-sensor readout by causing a readout circuit to read the pressure change resulting from the stimulus.

At operation block 1006, the processor 210 receives pressure data such as a pressure-signal indicating a change in pressure of the cavity of the apparatus is response to the stimulus. At operation block 1008, the processor 210 analyzes the pressure change, for example by analyzing amplitude and decay-time constant of the section 702 and 704 of the chart 700 of FIG. 7. At operation block 1010, the processor 210 determines a whether a leak exists in the seal of the housing (e.g., 202 of FIG. 2). The processor 210 may report the result of the analysis to a UI installed on the electronic device to be suitably displayed to the user.

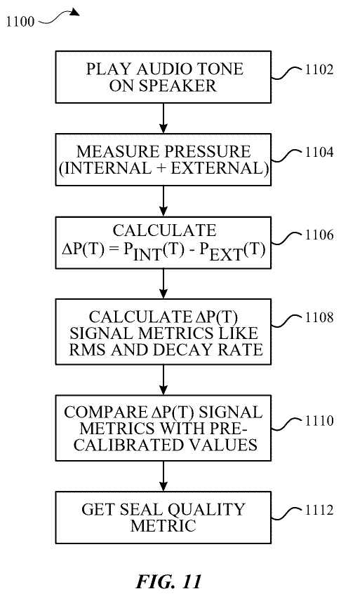

FIG. 11 is a flow diagram illustrating an example of a process 1100 for acoustic seal-integrity diagnosis, according to one or more implementations of the subject technology. The process 1100 is a process of seal-integrity diagnosis by using an internal pressure change of the cavity (e.g., 250 of FIG. 2) of an apparatus (e.g., an electronic device) such as the apparatus 200 of FIG. 2 due to an audio stimulus. The process 1100 starts at operation block 1102, where the processor 210 of FIG. 2 causes an audio driver (e.g., 260 of FIG. 2) to emit an audio tone (e.g., as shown by the chart 700 of FIG. 7) on the speaker (e.g., 262 of FIG. 2). At operation block 1104, the processor 210 causes readout of the measured internal and external pressures of the cavity (e.g., 250 of FIG. 2) by the first pressure sensor (e.g., 240 of FIG. 2), and the second pressure senor (e.g., 242 of FIG. 2), respectively.

At operation block 1106, the processor 210 calculates a pressure difference between the measured internal and external pressures of the cavity 250. At operation block 1108, the processor 210 calculates pressure-change signal (ΔP(t)) metrics such as a root-mean square (RMS) of the signal and a decay-time constant. At operation block 1110, the processor 210 compares the ΔP(t) signal metrics with a precalibrated value. At operation block 1112, the processor 210 obtains the seal-quality metric based on the comparison of the ΔP(t) signal metrics with the precalibrated value.

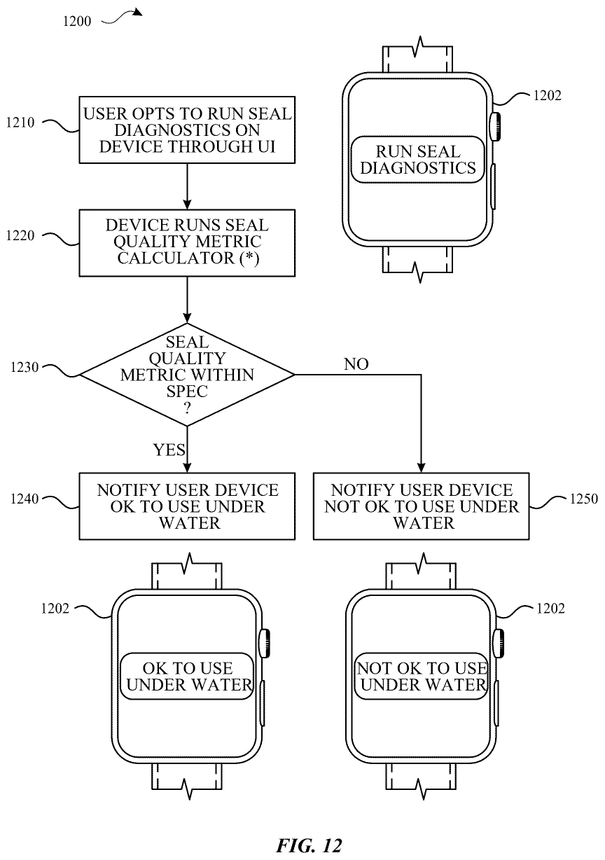

FIG. 12 is a flow diagram illustrating an example of a process 1200 for seal-integrity diagnosis, according to one or more implementations of the subject technology. The process 1200 starts at operation block 1210, where the user of apparatus 200 of FIG. 2 (e.g., a device such as a smartwatch 1202) decides to run a seal diagnostic on the device through a UI. At operation block 1220, the processor (e.g., 210 of FIG. 2) of the device runs a seal-quality metric calculator application to obtain a seal-quality metric.

At operation block 1230, the processor determines whether the obtained seal-quality metric is within a specification. If the obtained seal-quality metric is within the specification, at operation block 1240, the processor 210 causes the UI to notify the user that it is fine to use the device 1202 under the water. If the obtained seal-quality metric is not within the specification, at operation block 1250, the processor 210 causes the UI to notify the user that the device 1202 is not ready (e.g., may have a degraded seal) for being used under the water.

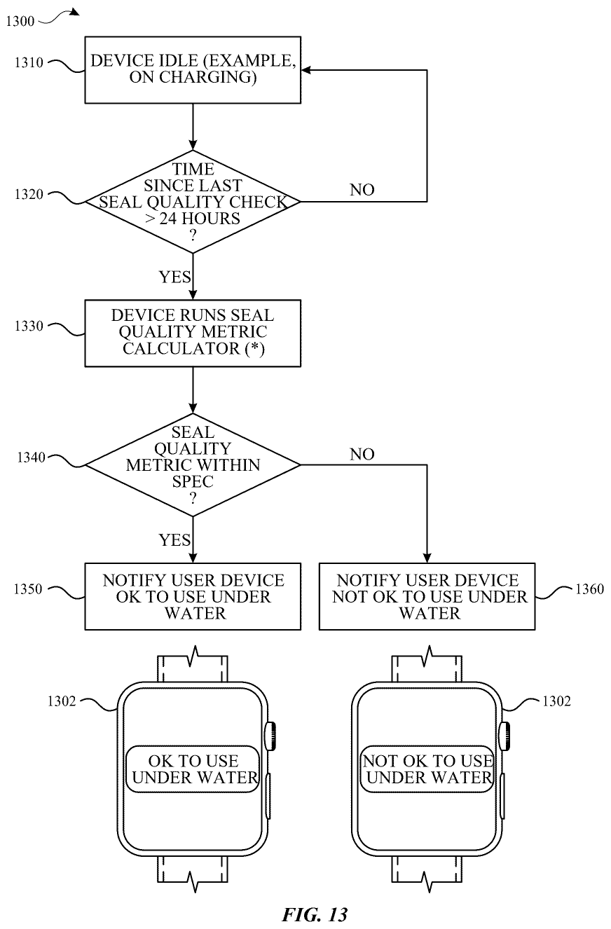

FIG. 13 is a flow diagram illustrating an example of a process 1300 for seal-integrity diagnosis, according to one or more implementations of the subject technology. The process 1300 starts at operation block 1310, where a device such as the smartwatch is idle (e.g., charging). At operation block 1320, the processor (e.g., 210 of FIG. 2) of the device determines whether the lapsed time since the last seal-quality check is more than a pre-determined time (e.g., 24 hours). If the elapsed time is more than the pre-determined time, at operation block 1330, the processor 210 runs a seal-quality metric calculator to find a seal-quality metric of the device. If the elapsed time not more than the pre-determined time, the processor 210 returns the control to the operation block 1310.

At operation block 1340, the processor 210 determines whether the obtained seal-quality metric is within a specification. If the obtained seal-quality metric is within the specification, at operation block 1350, the processor 210 causes the UI to notify the user that it is fine to use the device 1302 under the water. If the obtained seal-quality metric is not within the specification, at operation block 1360, the processor 210 causes the UI to notify the user that the device 1302 is not ready (e.g., may have a degraded seal) for being used under the water.

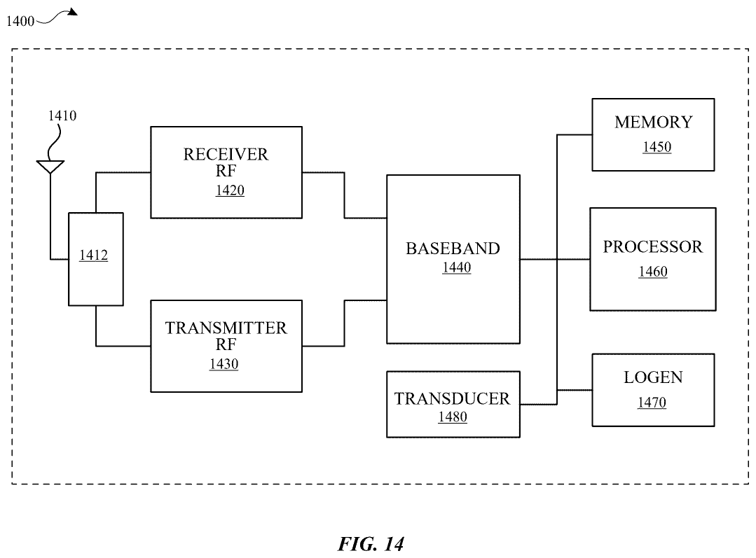

FIG. 14 is a schematic diagram illustrating an example of an electronic device 1400 within which aspects of the subject technology may be implemented. In some aspects, the electronic device 1400 may represent a communication device (e.g., a smartphone, or smartwatch), a tablet, a laptop, or any other electronic device. The electronic device 1400 may comprise a radio frequency (RF) antenna 1410, a receiver 1420, a transmitter 1430, a baseband processing module 1440, a memory 1450, a processor 1460, a local oscillator generator (LOGEN) 1470, and a transducer 1480. In various embodiments of the subject technology, one or more of the blocks represented in FIG. 14 may be integrated on one or more semiconductor substrates. The blocks 1420-970, for example, may be realized on a single chip, a single system on a chip, or on a multi-chip chipset.

The RF antenna 1410 may be suitable for transmitting and/or receiving RF signals (e.g., wireless signals) over a wide range of frequencies. Although a single RF antenna 1410 is illustrated, the subject technology is not so limited.

The receiver 1420 may comprise suitable logic, circuitry, and/or code that may be operable to receive and process signals from the RF antenna 1410. The receiver 1420 may, for example, be operable to amplify and/or down-convert received wireless signals. In various embodiments of the subject technology, the receiver 1420 may be operable to cancel noise in received signals, and may be linear over a wide range of frequencies. In this manner, the receiver 1420 may be suitable for receiving signals in accordance with a variety of wireless standards, including Wi-Fi, WiMAX, Bluetooth, and other various cellular standards. In various embodiments of the subject technology, the receiver 1420 may not require any SAW filters, and few or no off-chip discrete components, such as large capacitors, and inductors.

The transmitter 1430 may comprise suitable logic, circuitry, and/or code that may be operable to process and transmit signals from the RF antenna 1410. The transmitter 1430 may, for example, be operable to up-convert baseband signals to RF signals and amplify RF signals. In various embodiments of the subject technology, the transmitter 1430 may be operable to up-convert and amplify baseband signals processed in accordance with a variety of wireless standards. Examples of such standards may include Wi-Fi, WiMAX, Bluetooth, and other various cellular standards. In various embodiments of the subject technology, the transmitter 1430 may be operable to provide signals for further amplification by one or more power amplifiers.

The duplexer 1412 may provide isolation in the transmit band to avoid saturation of the receiver 1420, damaging parts of the receiver 1420, and/or to relax one or more design requirements of the receiver 1420. Furthermore, the duplexer 1412 may attenuate the noise in the receive band. The duplexer may be operable in multiple frequency bands for various wireless standards.

The baseband processing module 1440 may comprise suitable logic, circuitry, interfaces, and/or code that may be operable to perform processing of baseband signals. The baseband processing module 1440 may, for example, analyze received signals, generate control, and/or provide feedback signals for configuring various components of the electronic device 1400, such as the receiver 1420. The baseband processing module 1440 may be operable to encode, decode, transcode, modulate, demodulate, encrypt, decrypt, scramble, descramble, and/or otherwise process data in accordance with one or more wireless standards. In some implementations, the baseband processing module 1440 may include an intelligent boot circuit, and perform the functionalities of the intelligent boot of the subject technology, as described above.

The processor 1460 may comprise suitable logic, circuitry, and/or code that may enable processing data and/or controlling operations of the electronic device 1400. In this regard, the processor 1460 may be enabled to provide control signals to various other portions of the electronic device 1400. The processor 1460 may also control transfers of data between various portions of the electronic device 1400. Additionally, the processor 1460 may enable the implementation of an operating system, or otherwise execute code to manage the operations of the electronic device 1400.

In some implementations, the processor 1460 may replace or execute some or all of the functionalities of the processor 210 of FIG. 2 as described above with respect to FIGS. 2, 3, 6, 10-13 to determine whether a seal of the electronic device 1400 is breached, and to notify the user through a UI that that device is not ready to be used under water.

The memory 1450 may comprise suitable logic, circuitry, and/or code that may enable the storage of various types of information, such as received data, generated data, code, and/or configuration information. The memory 1450 may comprise, for example, RAM, ROM, flash, and/or magnetic storage. In various embodiments of the subject technology, information stored in the memory 1450 may be utilized for configuring the receiver 1420 and/or the baseband processing module 1440.

The local oscillator generator (LOGEN) 1470 may comprise suitable logic, circuitry, interfaces, and/or code that may be operable to generate one or more oscillating signals of one or more frequencies. The LOGEN 1470 may be operable to generate digital and/or analog signals. In this manner, the LOGEN 1470 may be operable to generate one or more clock signals and/or sinusoidal signals. Characteristics of the oscillating signals, such as the frequency and the duty cycle, may be determined based on one or more control signals from, for example, the processor 1460 and/or the baseband processing module 1440.

In operation, the processor 1460 may configure the various components of the electronic device 1400 based on a wireless standard according to which it is desired to receive signals. Wireless signals may be received via the RF antenna 1410, amplified, and down converted by the receiver 1420. The baseband processing module 1440 may perform noise estimation and/or noise cancellation, decoding, and/or demodulation of the baseband signals. In this manner, information in the received signal may be recovered and utilized appropriately. For example, the information may be audio and/or video to be presented to a user of the electronic device, data to be stored in the memory 1450, and/or information affecting and/or enabling the operation of the electronic device 1400. The baseband processing module 1440 may modulate, encode, and perform other processing on audio, video, and/or control signals to be transmitted by the transmitter 1430 in accordance with various wireless standards.

In some implementations, the transducer 1480 may be a pressure sensor, for example, an internal pressure sensor (e.g., 240 of FIG. 2), an external pressure sensor (e.g., 242 of FIG. 2), or an audio sensor (e.g., 290 of FIG. 2) and be used, as described above, to perform a seal-integrity diagnostic of the electronic device 1400.

As used herein, the phrase “at least one of” preceding a series of items, with the terms “and,” or “or” to separate any of the items, modifies the list as a whole rather than each member of the list (i.e., each item). The phrase “at least one of” does not require selection of at least one of each item listed; rather, the phrase allows a meaning that includes at least one of any one of the items, at least one of any combination of the items, and/or at least one of each of the items. By way of example, the phrases “at least one of A, B, and C,” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but rather are intended to be used interchangeably. In one or more implementations, a processor configured to monitor and control an operation or a component, may also mean the processor being programmed to monitor and control the operation, or the processor being operable to monitor and control the operation. Likewise, a processor configured to execute code can be construed as a processor programmed to execute code or operable to execute code.

Phrases such as “an aspect,” “the aspect,” “another aspect,” “some aspects,” “one or more aspects,” “an implementation,” “the implementation,” “another implementation,” “some implementations,” “one or more implementations,” “an embodiment,” “the embodiment,” “another embodiment,” “a configuration,” “the configuration,” “another configuration,” “some configurations,” “one or more configurations,” “the subject technology,” “the disclosure,” “the present disclosure,” or any other variations thereof and alike are for convenience, and do not imply that a disclosure relating to such phrase(s) is essential to the subject technology, or that such disclosure applies to all configurations of the subject technology. A disclosure relating to such phrase(s) may apply to all configurations, or to one or more configurations. A disclosure relating to such phrase(s) may provide one or more examples. A phrase such as “an aspect,” or “some aspects,” may refer to one or more aspects and vice versa, and this applies similarly to other foregoing phrases.

The word “exemplary” is used herein to mean “serving as an example, instance, or illustration.” Any embodiment described herein as “exemplary” or as an “example,” is not necessarily to be construed as preferred or advantageous over other implementations. Furthermore, to the extent that the terms “include,” “have,” or the like are used in the description or the claims, such terms are intended to be inclusive in a manner similar to the term “comprise,” as “comprise” is interpreted when employed as a transitional word in a claim.

All structural and functional equivalents to the elements of the various aspects described throughout this disclosure that are known, or later come to be known, to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112 (f) unless the element is expressly recited using the phrase “means for,” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one,” unless specifically so stated, but rather “one or more.” Unless specifically stated otherwise, the term “some” refers to one or more. Pronouns in the masculine (e.g., his), include the feminine and neutral genders (e.g., her and its), and vice versa. Headings and subheadings, if any, are used for convenience only, and do not limit the subject disclosure.

What is claimed:

1. An apparatus, comprising:
a housing;
an audio sensor configured to detect an acoustic pressure in a cavity of the housing; and
a processor configured to determine a level of a leak of the housing based at least in part on the acoustic pressure.

2. The apparatus of claim 1, further comprising a pressure sensor disposed inside the housing, the pressure sensor configured to measure an internal pressure of the housing.

3. The apparatus of claim 1, wherein the processor is further configured to determine a frequency-dependent acoustic signature of the acoustic pressure.

4. The apparatus of claim 3, wherein the processor is further configured to detect a change in a resonance of the acoustic pressure in the frequency-dependent acoustic signature.

5. The apparatus of claim 3, wherein the processor is configured to determine a presence of the leak within the cavity based at least in part on the frequency-dependent acoustic signature.

6. The apparatus of claim 1, wherein the processor is configured to activate a pressure-change stimulus to cause a change in the acoustic pressure.

7. The apparatus of claim 6, wherein the apparatus further comprises an audio driver and a speaker, and wherein the pressure-change stimulus comprises an audio stimulus.

8. The apparatus of claim 7, wherein the processor is configured to activate the pressure-change stimulus by causing the audio driver to play an audio signal on the speaker.

9. A device, comprising:
a housing;
an audio sensor configured to detect an acoustic pressure in a cavity of the housing;
a pressure sensor configured to measure an internal pressure of the housing;
an audio driver configured to produce a sound to be played by a speaker; and
a processor configured to:
determine a frequency-dependent acoustic signature of the acoustic pressure, and
determine a seal-quality metric of the housing based at least in part on the frequency-dependent acoustic signature.

10. The device of claim 9, wherein the processor is further configured to detect a leak resonance in the frequency-dependent acoustic signature.

11. The device of claim 10, wherein the seal-quality metric is an indication of a level of a leak of the housing, and wherein the seal-quality metric is determined based on a comparison of the leak resonance with a predetermined value.

12. The device of claim 9, wherein the processor is configured to activate the audio driver to play the sound on the speaker.

13. The device of claim 9, wherein the processor is configured to activate a pressure-change stimulus to cause a change in the acoustic pressure.

14. The device of claim 13, wherein the pressure-change stimulus comprises an audio stimulus.

15. The device of claim 13, wherein the processor is further configured to activate the pressure-change stimulus by causing the audio driver to play an audio signal on the speaker.

16. The device of claim 9, wherein the processor is configured to report a leak of the housing based on the frequency-dependent acoustic signature.

17. A mobile communication device, the device comprising:
a pressure sensor disposed in a housing and configured to measure an internal pressure of the housing;
an audio system including an audio driver and a speaker;
an audio sensor configured to detect an acoustic pressure in a cavity of the housing; and
a processor configured to:
determine a frequency-dependent acoustic signature of the acoustic pressure,
detect a leak resonance in the frequency-dependent acoustic signature, and
determine a seal-quality metric of the housing based at least in part on a comparison of the leak resonance with a predetermined value.

18. The mobile communication device of claim 17, wherein the seal-quality metric is an indication of a level of a leak of the housing.

19. The mobile communication device of claim 17, wherein the processor is configured to activate a pressure-change stimulus to cause a change in the acoustic pressure, and wherein the pressure-change stimulus comprises an audio stimulus.

20. The mobile communication device of claim 17, wherein the processor is further configured to report a leak of the housing based on the frequency-dependent acoustic signature.
